(19) United States
(12) Patent Application Publication
(10) Pub. No.: US 2009/0231370 A1
(43) Pub. Date: Sep. 17, 2009

(54) PRINTING SYSTEM, INKJET PRINTER, AND PRINTING METHOD

(75) Inventor: Masaru Ohnishi, Tomi-city (JP)

Correspondence Address: DITTHAVONG MORI & STEINER, P.C., 918 Prince St., Alexandria, VA, 22314, US

(73) Assignee: MIMAKI ENGINEERING CO., LTD., Tomi-city (JP)

(21) Appl. No.: 12/401,260

(22) Filed: Mar. 10, 2009

(30) Foreign Application Priority Data
Mar. 13, 2008 (JP) 2008-064958

(51) Int. Cl. B41J 29/38; B41J 2/04

(52) U.S. Cl. 347/9; 347/54

(57) ABSTRACT

A printing system includes an inkjet head and a decompressor. The inkjet head has nozzles configured to eject ink to a concavo-convex print surface a medium. The decompressor is configured to reduce a pressure in an area between the medium and the nozzles to be a pressure value lower than atmospheric pressure.

### CROSS-REFERENCE TO RELATED APPLICATIONS

The present application claims priority under 35 U.S.C. §119 to Japanese Patent Application. No. 2008-064958, filed Mar. 13, 2008. The contents of this application are incorporated herein by reference in their entirety.

### BACKGROUND OF THE INVENTION

1. Field of the Invention

The present invention relates to a printing system, an inkjet printer, and a printing method.

2. Discussion of the Background

Recently, a technology for printing a high resolution image by means of an inkjet printer has been widely used. The inkjet printer is an apparatus in which minuscule droplets of ink are ejected from nozzles of an inkjet head toward a medium so as to conduct printing on the medium.

Also recently, it is desired to print on various media other than, for example, paper or film by means of an inkjet printer. For example, it is desired to use the inkjet printer to print on a medium having concavo-convex print surface such as a three-dimensional article.

In case of using a medium having concavities and convexities, the distance between the nozzles of the inkjet head and the medium varies depending on the concavities and convexities of the print surface of the medium. Therefore, the inkjet printer is required to eject ink suitably to the concavities and convexities having different distances relative to the nozzles.

In case of using such a medium, however, the distance relative to the nozzles is increased at a concave surface of the medium as compared to the case of a convex surface. Increase in distance relative to the nozzles may easily cause, for example, a problem that the ink becomes fine mist so that it is difficult to eject the ink suitably to the medium. In addition, it may be difficult to adequately control the deposition accuracy of ink droplets ejected from the nozzles of the inkjet head. Further, in case of printing a high resolution image, the volume of each ink droplet is reduced, thus making the problem prominent.

As mentioned above, conventionally, it is difficult to adequately print in the inkjet method on such a medium having concavo-convex print surface.

Japanese Patent Application Publication No. 2004-134490 discloses a patterning apparatus using an inkjet head.

The inventor studied about the problem caused when printing is conducted in the inkjet method on a medium having concavo-convex print surface and focused on influence of air resistance on ink droplets ejected from the nozzles of the inkjet head.

Ink droplets ejected from the nozzles of the inkjet head are affected by air resistance before reaching the medium. In case of printing on a medium having concavo-convex print surface, the flying distance of the ink droplets must be longer than at least the distance between the nozzles and the concavity. However, as the flying distance of the ink droplets is increased, the influence of air resistance is increased. As the influence of air resistance is increased, the problem that the ink becomes fine mist easily occurs. Accordingly, using a medium having concavo-convex print surface is susceptible to the problem that the ink becomes fine mist.

The smaller the volume of the ink droplet is, the greater the influence of air resistance on the ink droplet is. If the volume of the ink droplet is reduced, the flying speed of the ink droplet is drastically reduced so as to cause a problem that the ink droplet becomes fine mist. However, if the volume of the ink droplet is increased in order to prevent the ink droplet from becoming fine mist, it is impossible to print a high resolution image.

In the medium having concavo-convex print surface, the distance between the medium and the nozzles varies at concavities and concavities. Accordingly, the influence of air resistance also varies depending on the location of the medium. As a result of this, it is difficult to control deposition of ink droplets on the medium to prevent misalignment. Therefore, in case of using such a medium, it is difficult to suitably eject ink droplets to the concavities and convexities, respectively.

### SUMMARY OF THE INVENTION

According to one aspect of the present invention, a printing system includes an inkjet head and a decompressor. The inkjet head has nozzles configured to eject ink to a concavo-convex print surface a medium. The decompressor is configured to reduce a pressure in an area between the medium and the nozzles to be a pressure value lower than atmospheric pressure.

According to another aspect of the present invention, an inkjet printer includes an inkjet head. The inkjet head has nozzles configured to eject ink in an area between a medium and the nozzles onto a concavo-convex print surface of the medium. A pressure in the area is reduced to be a pressure value lower than atmospheric pressure.

According to another aspect of the present invention, a method for printing includes providing a medium having a concavo-convex print surface. A pressure in an area is reduced between the medium and nozzles of an inkjet head to be a pressure value lower than atmospheric pressure. Ink is ejected to the print surface from the nozzles.

### DESCRIPTION OF THE EMBODIMENT

Embodiments will now be described with reference to the accompanying drawings, wherein like reference numerals designate corresponding or identical elements throughout the various drawings.

A printing system of a type printing in the inkjet method, includes an inkjet head having nozzles for ejecting ink to a medium having concavo-convex print surface; and a decompression means for reducing the pressure of at least an area between the medium and the nozzles of the inkjet head to a value lower than the normal atmospheric pressure. The decompression means preferably reduces the pressure of at least whole area between the medium and the nozzles. The medium having concavo-convex print surface is, for example, a three-dimensional article.

According to this arrangement, the influence of air resistance on ink droplets is reduced by reducing the pressure. For example, even when the volume of each ink droplet is small, the ink droplet hardly becomes fine mist. Therefore, it is possible to suitably eject ink droplets, for example, even relative to a concavity having a large distance from the nozzles. In addition, it is possible to eliminate differences in influence of air resistance depending on the position on the medium so as to suitably eject ink droplets onto the concavities and convexities of the print surface. According to this arrangement, adequate printing can be conducted in the inkjet method relative to the medium having concavo-convex print surface.

The inkjet head ejects ink droplets each having a volume of 3 picoliters (pl) or less, for example, from the nozzles. The inkjet head may eject ink droplets each having a volume of 1 pl or less. According to this arrangement, adequate printing of a high resolution image can be conducted relative to the medium having concavo-convex print surface. For printing a high resolution image, the volume of each ink droplet is preferably 0.5 pl or less, more preferably 0.1 pl or less.

The printing system further includes a medium supporting portion for supporting the medium to face the nozzles of the inkjet head by supporting the back surface of the medium opposite to the print surface, wherein the distance between the surface, supporting the medium, of the medium supporting portion and the nozzles is about 5 mm or more. The medium supporting portion is a platen which supports the medium on its upper surface, for example. The distance between the surface supporting the medium of the medium supporting portion and the nozzles may be 10 mm or more, or 20 mm or more. The distance is from 10 to 200 mm, preferably from 10 to 50 mm, more preferably from 10 to 20 mm.

According to this arrangement, it is possible to suitably support the medium having concavo-convex print surface. In addition, it is therefore possible to adequately print in the inkjet method.

The inkjet head ejects ink droplets onto the print surface of the medium while moving relative to the medium supporting portion in a direction in a plane parallel to the surface, supporting the medium, of the medium supporting portion.

For printing on the medium having concavo-convex print surface, for example, it can be considered that moving the inkjet head forward or backward in a direction perpendicular to the print surface of the medium according to the concavities and convexities of the print surface is effective. However, such a mechanism makes the printing system complex and increases the cost.

To solve this problem, according to this arrangement, the inkjet head can be adapted to move relative to the medium only to scan in plane directions in a plane parallel to the print surface. Therefore, according to this arrangement, it is possible to suitably prevent the printing system from becoming complex and prevent the cost from increasing.

When printing on the medium having concavo-convex print surface in the atmosphere, it is difficult to adequately print even when the inkjet head is moved only to scan in the plane directions due to large influence of air resistance. To solve this problem, according to this arrangement, the influence of air resistance is reduced by reducing the pressure so that it is possible to print relative to the medium having concavo-convex print surface only by scanning in the plane directions.

The maximum distance between the print surface of the medium and the nozzle face of the inkjet head is about 5 mm or more. The nozzle face of the inkjet head is a face, in which openings of the nozzles exist, of the inkjet head. The maximum distance may be, for example, 10 mm or more, or 20 mm or more. The maximum distance is from 5 to 200 mm, preferably from 5 to 50 mm, more preferably from 5 to 20 mm.

The distance relative to the nozzle face becomes the maximum at the deepest concavity of the print surface. When the maximum distance is large and printing is conducted in the atmosphere, such a problem that the ink droplet becomes fine mist especially easily occurs because the flying distance of the ink droplet must be large at the concavity. When there is such deep concavity so that there is large difference in level between the highest convexity and the deepest concavity of the print surface, the difference in influence of air resistance is large between the convexity and the concavity. Especially in this case, it is difficult to conduct adequate printing.

To solve this problem, according to this arrangement, the ink droplet is prevented from becoming fine mist by reducing the pressure even at the concavity where the flying distance of the ink droplet is large. This can also reduce the difference between the air resistance at the convexity and the air resistance at the concavity. Therefore, according to this arrangement, it is possible to print in the inkjet method even relative to the medium having concavo-convex print surface.

The saturated vapor pressure of the main component of the ink at a temperature of 25° C. is about 1/20 atm or less. The saturated vapor pressure of the main component of the ink is preferably 10 mmHg or less, more preferably 5 mmHg or less, for example. The entire saturated vapor pressure of the ink is preferably about 1/20 of the normal atmospheric pressure (1 atm), for example.

The inventor of the present invention intensely studied and found that, in an inkjet printer which is structured to eject liquid ink, it is impossible to suitably reduce the air resistance even though it is tried to reduce the pressure because the range of suitable pressure allowing stable use of ink is small. In case of using conventionally known ink, it is difficult to sufficiently reduce the pressure even when it is tried to reduce the pressure of the area between the nozzles and the medium because components of the ink are affected by the vapor pressure so as to evaporate so that the characteristics of ink vary. Therefore, since the pressure cannot be sufficiently reduced even by simply using a decompression means, it is difficult to sufficiently and suitably reduce influence of air resistance on ink droplets.

However, according to this arrangement, it is possible to adequately reduce the influence of vapor pressure of the ink. In addition, this can suitably reduce the pressure of the area between the nozzles and the medium. According to the arrangement, therefore, the influence of air resistance on the ink droplets can be sufficiently and suitably reduced. Therefore, according to this arrangement, it is possible to adequately print relative to the medium having concavo-convex print surface.

The main component of the ink means a component making up the highest percentage of the ink. The contained amount of the main component in the ink is, for example, 50% or more, preferably 65% or more (for example, 65-85%). The saturated vapor pressure of the main component in the ink means a saturated vapor pressure under environment for the printing. For example, the saturated vapor pressure in this example is a saturated vapor pressure at a temperature of 25° C. Further, the saturated vapor pressure may be a vapor pressure in normal atmospheric pressure, i.e. 1 atm, at a temperature of 25° C.

The ink contains at least one of monomer and oligomer as the its main components and is curable by polymerization of the main component. The ink is polymerizable and curable by irradiation of light (for example, visible light), ultraviolet light, electron beam, radiation ray, or heat. For example, the ink may be UV curable ink or thermosetting ink. The ink may be ink that is curable by irradiation of electron beam.

When the saturated vapor pressures of components (volatile components) of the ink are low, it is too much time to dry the ink by evaporation of the components of the ink similarly to water-base inks and solvent inks. If the medium is heated for promoting the evaporation, it is required to heat to a high temperature so that the medium may be deformed by the heat. If the ink cannot be sufficiently dried, bleeding may be caused, leading to reduction in printing quality. Therefore, if the ink used in the printing system according to the embodiment of the present invention is of a type that is fixed to the medium by drying, it may be difficult to adequately conduct the printing.

According to this arrangement, however, since ink which is curable by polymerization of the main component by irradiation of light (for example, visible light), ultraviolet light, electron beam, radiation ray, or heat is used, the ink can be fixed to the medium without evaporation of components of the ink. Therefore, according to this arrangement, adequate printing can be conducted using ink of which components have low saturated vapor pressures.

It should be noted that the ink may contain both monomer and oligomer as its main components. This, i.e. the ink contains both monomer and oligomer as its main components, means that the total contained amount of the monomer and the oligomer is larger than any of other components, for example. In this case, the contained amount of the main component may be the total contained amount of the monomer and the oligomer.

The ink further contains an initiator for the polymerization, for example. The saturated vapor pressure of the initiator is 10 mmHg or less, preferably 5 mmHg or less. According to this arrangement, the influence of the vapor pressure of the ink can be further suitably reduced. Therefore, the influence of air resistance on the ink droplets can be further suitably reduced.

The ink further contains, for example, a pigment, dispersant, an antigelling agent, a surface conditioner, and the like. The ink may further contain various additives. It is preferable that the saturated vapor pressure of any of substantial components is 10 mmHg or less. The saturated vapor pressure of any of substantial components is further preferably 5 mmHg or less.

The substantial component means a component remaining in the ink as composition of the ink in the inkjet head, for example. The substantial components of the ink are preferably all of the compositions of the ink. In practice, the substantial components of the ink may be a part occupying 95% or more of the compositions, except a part of which contained amount is small.

The decompression means reduces the pressure in the area between the medium and the nozzles to about 0.5 atm or less. The decompression means preferably reduces the pressure of the area between the medium and the nozzles to 0.1 atm or less, more preferably 0.01 atm or less. This arrangement can largely reduce the influence of air resistance. In addition, according to this arrangement, it is possible to adequately print relative to the medium having concavo-convex print surface.

An inkjet printer of a type printing in the inkjet method, includes an inkjet head having nozzles for ejecting ink to a medium having concavo-convex print surface, wherein the pressure of at least an area between the medium and the nozzles of the inkjet head is reduced to a value lower than the normal atmospheric pressure.

A printing method for printing in the inkjet method, includes preparing a medium having concavo-convex print surface; reducing the pressure of at least an area between a medium and nozzles of an inkjet head to a value lower than the normal atmospheric pressure, and ejecting ink droplets to the medium from the nozzles of the inkjet head.

According to the embodiment of the present invention, for example, it is possible to adequately print in the inkjet method onto a medium having concavo-convex print surface.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an illustration showing an example of structure of a printing system 10 according to an embodiment of the present invention;

FIG. 2 is a graph for explaining the relationship between the kinetic energy of an ink droplet and air resistance;

FIGS. 3A and 3B are illustrations showing an example of influence of air resistance on ink droplets. FIG. 3A schematically shows an example of state of an ink droplet ejected from the inkjet head 102 which is moving in the Y direction. FIG. 3B schematically shows an example of state of an ink droplet in case that the ink is ejected in a horizontal direction; and

FIGS. 4A and 4B are illustrations for explaining the flying distance of the ink droplet. FIG. 4A is a graph showing an example of relationship between the radius of the droplet and the maximum flying distance under the normal atmospheric pressure. FIG. 4B is a table showing an example of relationship between the pressure in the area between the nozzle 202 of the inkjet head 102 and the medium 50 and the maximum flying distance of the droplet.

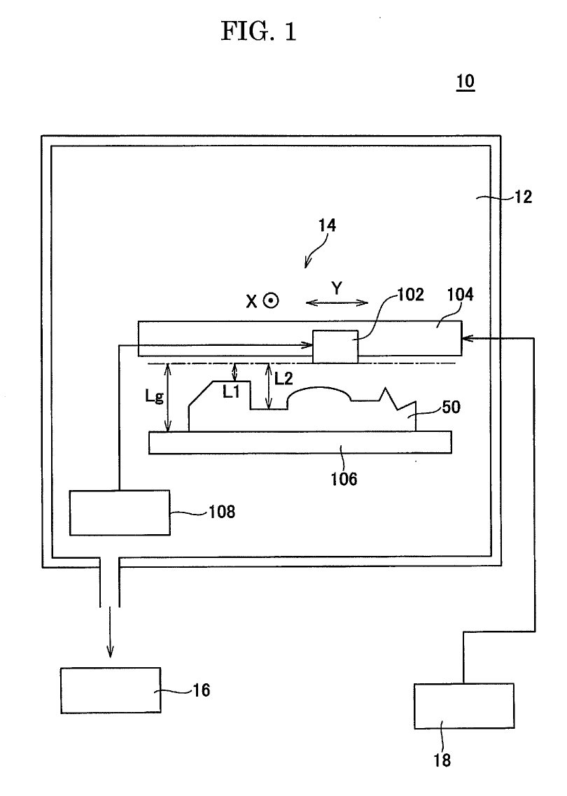

FIG. 1 shows an example of the structure of a printing system 10 according to an embodiment of the present invention. The printing system 10 is a printing system of a type conducting printing in an inkjet method onto a medium 50 and includes an inkjet printer 14, and a vacuum pump 16.

In this embodiment, the printing system 10 prints on the medium 50 having concavo-convex print surface. The medium 50 having concavo-convex print surface is, for example, a three-dimensional article. The three-dimensional article may be, for example, a three-dimensional product or package. In this case, the printing system 10 conducts printing on a surface of a three-dimensional product or package. The medium 50 may be a three-dimensional molding made of resin.

In the printing system 10, at least the inkjet printer 14 is disposed within a decompression chamber 12. The decompression chamber 12 is an airtight chamber accommodating the inkjet printer 14 therein and is decompressed by a vacuum pump 16. The printing system 10 conducts printing according to the control of an outside host PC 18. The host PC 18 is a computer for controlling the printing actions of the inkjet printer 14.

The inkjet printer 14 is a printing device for printing in the inkjet method and includes an inkjet head 102, a guide rail 104, an ink cartridge 108, and platen 106. The inkjet head 102 is a print head having nozzles for ejecting ink droplets onto a print surface of the medium 50. In this embodiment, the inkjet head 102 ejects ink droplets, each having a volume of 3 picoliters (hereinafter, referred to as “pl”) or less, from the nozzles. The volume of ink droplet is preferably 1 μl or less, more preferably 0.5 μl or less, still more preferably 0.1 μl or less.

The inkjet head 102 reciprocates in a Y direction as a predetermined scan direction along the guide rail 104 so that the inkjet head 102 ejects ink droplets at desired positions on the medium 50 in the Y direction. Further, the inkjet head 102 moves in an X direction perpendicular to the Y direction relative to the medium 50 so that the inkjet head 102 ejects ink droplets at desired position on the medium 50 in the X direction.

The inkjet printer 14 moves the inkjet head 102 in the X direction relative to the medium 50 by, for example, feeding the medium 50. In this case, the inkjet printer 14 further includes rollers or the like for feeding the medium 50. In the inkjet printer 14, the inkjet head 102 may be moved not feeding the medium 50.

The guide rail 104 is a member for guiding the movement of the inkjet head 102 in the Y direction and may move the inkjet head 102 to scan according to a command of the host PC 18. The ink cartridge 108 is a cartridge of storing ink to be ejected from the inkjet head 102 and is connected to the inkjet head 102 to supply ink to the inkjet head 102 via an ink supplying path such as a tube.

The platen 106 is an example of a medium supporting member and supports the medium 50 to face the inkjet head 102. The platen 106 is a base member disposed to face the inkjet head 102 via the medium 50 and supports the medium 50 thereon such that the bottom surface opposite to the print surface of the medium 50 abuts on the upper surface of the platen 106.

In this embodiment, the gap size Lg, i.e. the distance between the upper surface of the platen 106 and the nozzles of the inkjet head 102, is about 5 mm or more (for example, from 5 to 200 mm, preferably from 5 to 50 mm, more preferably from 5 to 20 mm). The gap size Lg may be 10 mm or more or 20 mm or more. According to this embodiment, it is possible to suitably support a medium 50 having large thickness when the gap size Lg is large i.e. in case of wide gap. In addition, it is also possible to suitably support a medium having concavo-convex print surface.

The vacuum pump 16 is an example of decompression means and reduces the inner pressure of the decompression chamber 12 according to the operation of an operator, for example. Therefore, the vacuum pump 16 reduces the pressure in an area between the nozzles of the inkjet head 102 and the medium 50 in the inkjet printer 14 to a value lower than the normal atmospheric pressure. In this embodiment, the vacuum pump 16 reduces the pressure of the area to about 0.5 atm or less (for example, from 0.001 to 0.5 atm), preferably 0.1 atm or less, more preferably 0.01 atm or less.

In a variation embodiment of the present invention, the vacuum pump 16 may be structured as a component of the inkjet printer 14. In this case, for example, the inkjet printer 14 itself is the printing system 10. In addition, instead of the decompression chamber 12 accommodating the entire inkjet printer 14, a decompression chamber as a component of the inkjet printer 14 may be provided. For example, the decompression chamber is an airtight chamber surrounding at least an area between the inkjet head 102 and the medium 50. In this case, by reducing the inner pressure of the decompression chamber, the vacuum pump 16 reduces the pressure at the area between the nozzles of the inkjet head 102 and the medium 50 to a value lower than the normal atmospheric pressure. The decompression chamber may be disposed in a printing unit which is detachably attached to the inkjet printer 14.

Hereinafter, the detail description will be made as regard to ink used in this embodiment. In this embodiment, the ink is ink which contains a monomer as its main component and is curable by polymerization of the monomer. For example, the ink may be UV curable ink which is curable by polymerization of the monomer when irradiated with ultraviolet light.

In this case, the UV curable ink contains, for example, a pigment, a dispersant, an initiator (sensitizer), an antigelling agent, a surface conditioner, a monomer, and an oligomer. The contained amount of the monomer is, for example, from 65 to 85%, and the contained amount of the oligomer is, for example, from 10 to 20%. The contained amount of the pigment is, for example, about 4% and the contained amount of the initiator is, for example, about 7%. The contained amounts of the dispersant, the antigelling agent, and the surface conditioner are several percents, respectively.

Also in this case, the saturated vapor pressure of the monomer as the main component at a temperature of 25° C. is, for example, about 1/20 atm or less (for example, from 0.01 to 10 mmHg), preferably 5 mmHg or less (for example, from 2 to 3 mmHg). The saturated vapor pressure of the oligomer and the initiator as the major components is also, for example, about 1/20 atm or less (for example, from 0.01 to 10 mmHg), preferably 5 mmHg or less (for example, from 2 to 3 mmHg). The saturated vapor pressure of the other components, each occupying 1% or more of the ink, is also about ½ atm or less (for example, from 0.01 to 10 mmHg), preferably 5 mmHg or less (for example, from 2 to 3 mmHg).

According to this embodiment, influence of the vapor pressure of the ink can be suitably reduced when the pressure in the decompression chamber 12 is reduced by the vacuum pump 16. Therefore, the inner pressure of the decompression chamber 12 can be suitably reduced, thereby sufficiently and suitably reducing the air resistance to which the ink droplets are subjected.

Also in this embodiment, the ink that is curable by polymerization of monomer is used so that the ink can be fixed to the medium 50 without evaporation of components of the ink. According to this embodiment, therefore, adequate printing can be conducted using ink of which components have low saturated vapor pressures.

As the ink that is curable by polymerization of monomer, for example, thermosetting ink that is curable by heating or ink that is curable by irradiation of electron beam or radiation ray may be used. In these cases, the saturated vapor pressures of respective components are preferably the same as or similar to the saturated vapor pressures as mentioned above. Accordingly, similarly to the UV curable ink, adequate printing can be conducted using ink of which components have low saturated vapor pressures.

As the ink, ink containing a component other than monomer as its main component may be used. For example, ink containing oligomer as its main component may be used. Further, ink containing both monomer and oligomer as its main components may be used. In these cases, the saturated vapor pressure of the main component is, for example, preferably 10 mm Hg or less, more preferably 5 mmHg or less.

Now, printing actions relative to the medium 50 having concave-convex print surface will be described in detail. In this embodiment, the maximum difference in level between concaves and convexes on the print surface of the medium 50 is about 5 mm or more (for example, 5-200 mm, preferably 5-50 mm, more preferably 5-20 mm). The thickness of the medium 50 is smaller than the gap size Lg. Therefore, the maximum difference in level is also smaller than the gap size Lg. Since the maximum difference in level between concaves and convexes is about 5 mm or more, the maximum distance between the nozzle face of the inkjet head 102 and the print surface of the medium 50 is at least about 5 mm or more.

The maximum difference in level between concaves and convexes is a difference in level between the highest convexity and the deepest concavity of the print surface. The convexity of the print surface is a portion of which distance from the nozzles of the inkjet head 102 is smaller than those of portions around it. The concavity is a portion of which distance from the nozzles of the inkjet head 102 is larger than those of portions around it. The highest convexity is a portion of which distance from the nozzles of the inkjet head 102 is minimum among all portions in a region, onto which ink droplets are ejected, of the print surface. In this embodiment, the distance between the highest convexity and the nozzles of the inkjet head 102 is “L1”. The deepest concavity is a portion of which distance from the nozzles of the inkjet head 102 is maximum among all portions in a region, onto which ink droplets are ejected, of the print surface. In this embodiment, the distance between the deepest concavity and the nozzles of the inkjet head 102 is “L2”. In this case, the difference in level between the highest convexity and the deepest concavity of the print surface is “L2-L1”.

The distance from the nozzles is a distance in the state that the portion concerned faces the openings of the nozzles. The state that the portion concerned faces the openings of the nozzles is a state that the openings of the nozzles are positioned opposite to the portion concerned in the ink ejection direction by movement of the inkjet head 102 relative to the medium 50.

For printing on the medium 50 as mentioned above, the inkjet head 102 ejects ink to the print surface of the medium 50 while moving relative to the platen in the direction in X-Y plane. The Y-Y plane is a plane parallel to the X direction and the Y direction as mentioned above and is parallel to the upper surface of the platen 106 directly below the inkjet head 102.

Therefore, in this embodiment, the inkjet head 102 does not move in a direction (Z direction) perpendicular to the print surface of the medium and moves only in horizontal directions in the X-Y plane to eject ink droplets to respective points on the print surface of the medium 50. According to this embodiment, it is possible to achieve adequate printing relative to the medium 50 having concavo-convex print surface without need of a complex mechanism and the like.

In this embodiment, influence of air resistance on ink can be reduced by reducing the pressure of an area between the nozzles of the inkjet head 102 and the medium 50. Therefore, it is possible to adequately prevent the ink from being fine mist. In addition, ink can be suitably ejected even relative to the concavity of which flying distance of the ink should be large because of large distance from the nozzles. Further, the volume of ink droplet can be suitably reduced. Moreover, the difference in influence of air resistance between convexity and concavity of the medium 50 can be reduced by decompression. Therefore, it is possible to suitably eject ink both to the convexity and the concavity of the print surface.

According to this embodiment, it is possible to achieve adequate printing of a high resolution image in the inkjet method relative to the medium 50 having concavo-convex print surface by using the inkjet printer 14 having the wide gap. Therefore, for example, it is possible to provide a cheap three-dimensional printer. Hereinafter, detail description will be made as regard to influence of air resistance on ink.

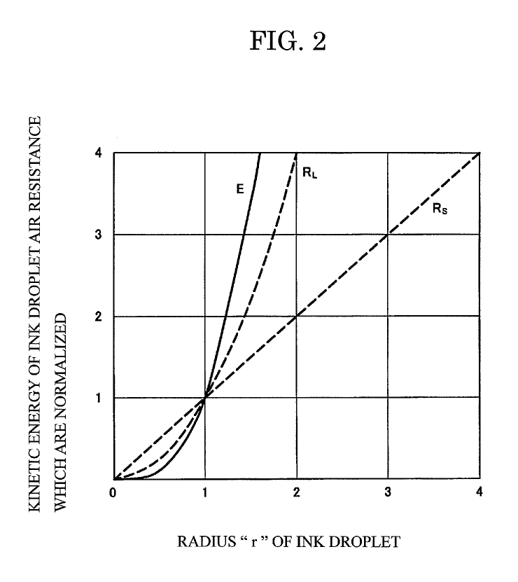

FIG. 2 is a graph for explaining the relationship between kinetic energy of ink droplet and air resistance. In this graph, respective components of the kinetic energy and the air resistance are normalized such that curves and a line indicating the respective components intersect at a coordinate point (1, 1).

When the speed of the ink droplet is represented by “v”, the kinetic energy “E” of the droplet is E=(½) mv². When the radius of the droplet is represented by “r”, the mass “m” of the droplet is proportional to “r³” because the mass “m” is proportional to the volume. Therefore, if the speed “v” of the droplet is constant, the kinetic energy of the droplet is proportional to “r³”.

It is known that the air resistance to which droplet is subjected includes air resistance component Rs which is proportional to the radius “r” of the droplet and air resistance component R_{L} which is proportional to the sectional area of the droplet. Since the sectional area of the droplet is proportional to “r²”, the air resistance component R_{L} is proportional to “r²”.

When the radius “r” of the droplet is enough small, the air resistance component Rs is larger than the air resistance component R_{L} so that the droplet is subjected to air resistance which is substantially proportional to the radius “r”. On the other hand, when the radius “r” of the droplet is enough large, the air resistance component R_{L} is larger than the air resistance component Rs so that the droplet is subjected to air resistance which is substantially proportional to the radius “r” squared (r²). Further, when the radius “r” of the droplet is a size between the both components, the droplet is subjected to air resistance in which the air resistance component Rs and the air resistance component R_{L} are combined. In this case, the air resistance to which the ink droplet is subjected is a value in a region between the curve indicating the air resistance component R_{L} and the line indicating the air resistance component Rs.

Taking the relationship between the kinetic energy of an ink droplet and the air resistance into consideration, as can be seen from the graph, the kinetic energy E of the droplet is large as compared to the air resistance when the radius “r” is increased. When the kinetic energy E of the droplet is enough large as compared to the air resistance, the droplet is hardly affected by the air resistance. On the other hand, when the radius “r” is small, the kinetic energy E of the droplet is small as compared to the air resistance. The smaller the radius “r” is, the easier the droplet is affected by the air resistance.

The speed of the ejected ink droplet decelerates with time according to the balance between the kinetic energy of the droplet and the air resistance. As the influence of air resistance is large, the ejected ink droplet immediately decelerates and thus easily becomes fine mist, for example. As the radius “r” of the droplet is small, it is difficult to ensure enough flying distance of the droplet.

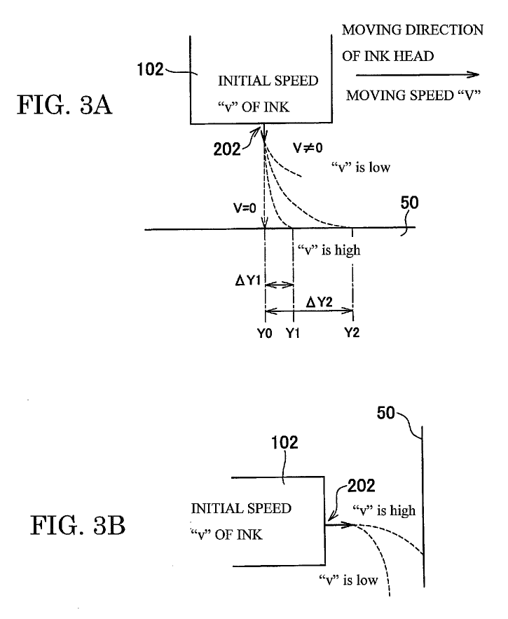

FIGS. 3A and 3B are illustrations showing an example of influence of air resistance on ink droplets. In the inkjet printer 14 of this embodiment (see FIG. 1), the inkjet head 102 has a plurality of nozzles. In the following description, however, description will be made as regard to an ink droplet ejected from only one nozzle 202 of the inkjet head 102 for ease of explanation. Also for the medium 50, the concavities and convexities of the print surface are omitted from these drawings for ease of explanation.

FIG. 3A schematically shows an example of state of an ink droplet ejected from the inkjet head 102 which is moving in the Y direction. In this example, the inkjet head 102 ejects the ink droplet downward in a vertical direction at an initial speed “v” from the nozzle 202. The inkjet head 102 moves at a moving speed “V” in the Y direction.

Now, a case that the inkjet head 102 ejects the ink droplet at a point Y0 in the Y direction (Y coordinate) will be considered. In this case, if the moving speed V of the inkjet head 102 is 0, an ink droplet ejected is deposited at a position Y0 in the Y coordinate on the medium 50 without any shift.

However, if the ink is ejected while the inkjet head 102 is moving at the moving speed V as actual printing, the deposition point (arrival point) of the ink droplet shifts from the point Y0 in the Y coordinate. The lower the initial speed “v” of the ink droplet is, the greater the deposition point shifts. For example, assuming that the deposition point in the Y coordinate when the ink droplet is ejected at a certain initial speed is Y1 and the deposition point in the Y coordinate when the ink droplet is ejected at an initial speed lower than the certain initial speed is Y2, the shifting amount of the latter case ΔY2=Y2−Y0 is greater than the shifting amount of the former case ΔY1=Y1−Y0.

To solve this problem, the inkjet printer 14 predicts the shifting amount of the deposition point based on the moving speed “V” of the inkjet head 102, the initial speed “v” of the ink droplet, the distance between the inkjet head 102 and the medium 50, and the like, so as to control the timing of ink ejection. In case of using the medium 50 having concavo-convex print surface like this embodiment, the timing of ink ejection is compensated according to the profile of the concavo-convex surface. Therefore, the inkjet printer 14 can deposit ink droplets at desired positions on the medium 50.

In case of ejecting ink droplets with large air resistance, for example, in the atmosphere, however, the speed of the ink droplet ejected from the inkjet head 102 is gradually reduced due to balance between the kinetic energy of the ink droplet and the air resistance between the ejection from the inkjet head 102 and the deposition on the medium 50. Accordingly, when the distance between the inkjet head 102 and the medium 50 is large, the influence of air resistance onto the shifting amount of deposition point is large so that it is difficult to adequately predict the shifting amount. As a result, it is difficult to adequately control the timing of ink ejection.

In case of using the medium 50 having concavo-convex print surface, the distance between the inkjet head 102 and the medium 50 varies depending on the position on the medium 50 so that the influence of air resistance also varies depending on the position on the medium 50. In this case, it is further difficult to adequately compensate the timing of ink ejection. As mentioned above, in case of printing in the inkjet method in the atmosphere, it is difficult to adequately print on the medium 50 having concavo-convex print surface.

When the air resistance is large as compared to the kinetic energy of the ink droplet, there may be not only a problem that the deposition point is shifted but also a problem that the ink droplet becomes fine mist because the speed is reduced to be too low, for example. Therefore, when influence of air resistance on the ink droplet is great, for example, as in the normal atmospheric pressure, ink droplet may be difficult be ejected if the volume of the ink droplet is small so that the kinetic energy of the ink droplet is small. Accordingly, in case of printing in the inkjet method in the atmosphere, it is especially difficult to print a high resolution image relative to the medium 50 having concavo-convex print surface.

To reduce the influence of air resistance, it can be considered that making the kinetic energy of ink droplet larger by increasing the mass of the ink droplet or the initial speed of ejection is effective. However, it is necessary to reduce the size of ink droplets in order to achieve the printing of a high resolution image which has been desired recently. Therefore, it is difficult to increase the mass of the ink droplet. Also for the initial speed of ejection, it is not easy to increase the initial speed of ejection because various optimization measures must be conducted in the structure of the inkjet printer. If the initial speed of ejection of small droplet is increased too much, the shape of droplet maintained by the surface tension cannot be maintained so as to spoil the suitable ejection.

To prevent the ink droplet from becoming fine mist, it can be considered that making the distance between the inkjet head 102 and the medium 50 small is effective. However, in case of using the medium 50 having concavo-convex print surface, the distance between the inkjet head 102 and the medium 50 at the concavity of the medium 50 must be large even though the distance between the inkjet head 102 and the medium 50 at the convexity is set to be small. That is, it is difficult to sufficiently prevent the ink droplet from becoming fine mist.

FIG. 3B schematically shows an example of state of an ink droplet in case that the ink is ejected in a horizontal direction. In the inkjet printer 14, the inkjet head 102 may be adapted to eject the ink from the nozzle 202 in the horizontal direction.

Also in this case, when the volume of the ink droplet is small, there is a problem that the ink becomes fine mist because the speed is reduced due to the balance between the kinetic energy of the ink droplet and the air resistance. In this case, the droplet is subjected to gravity acting downward in a vertical direction in addition to the air resistance. Accordingly, as the speed of the droplet is reduced due to the air resistance, the droplet falls downward in the vertical direction rather than moving toward the medium 50. In this case, therefore, it is further difficult to make the distance between the inkjet head 102 and the medium 50 large. Accordingly, also in this case, similarly to the case as explained above with reference to FIG. 3A, it is difficult to print a high resolution image relative to the medium 50 having concavo-convex print surface in case of printing in the inkjet method in the atmosphere.

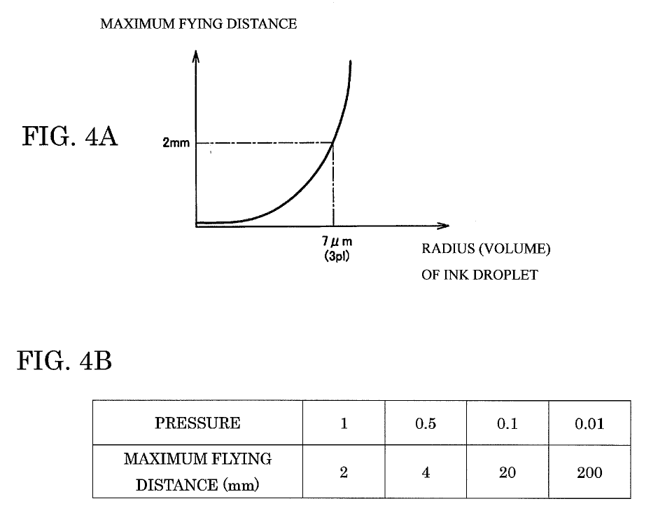

FIGS. 4A and 4B are illustrations for explaining the flying distance of the ink droplet. FIG. 4A is a graph showing an example of relationship between the radius of the droplet and the maximum flying distance under the normal atmospheric pressure. As described with regard to FIG. 2, the larger the radius of the ink droplet is, the larger the kinetic energy of the droplet is. When the kinetic energy of the droplet is large, the droplet is hard to be affected by the air resistance. Accordingly, the maximum distance that the droplet can be suitably ejected depends on the radius of the ink droplet.

As shown in the graph, the maximum flying distance of the ink droplet is 2 mm when the radius of the droplet is 7 μm. The droplet of 7 μm in radius corresponds to a droplet of about 3 pl in volume. Accordingly, when the volume of the ink droplet is 3 pl or less, it is difficult to make the inkjet printer 14 have a wide gap. Therefore, it is difficult to adequately print in the inkjet method relative to the medium having concavo-convex print surface.

When the volume of droplet is about 1 pl, the maximum flying distance of the droplet in the atmosphere should be about 1 mm. In this case, it is further difficult to print in the inkjet method in the atmosphere relative to the medium 50 having concavo-convex print surface. From this, it can be found that it must be difficult to print a high resolution image relative to the medium 50 having concavo-convex print surface in case of printing in the inkjet method in the atmosphere.

FIG. 4B is a table showing an example of relationship between the pressure in the area between the nozzle 202 of the inkjet head 102 and the medium 50 and the maximum flying distance of the droplet, of a case that the volume of the droplet is 3 pl. When the volume of the droplet is 3 pl, the maximum flying distance is about 2 mm in the normal atmospheric pressure (1 atm) as described in the above with reference to FIG. 4A.

When the pressure of the area between the nozzle 202 and the medium 50 is reduced to about 0.5 atm, 0.1 atm, and 0.01 atm by means of the structure of the printing system 10 of this embodiment, the influence of air resistance is reduced so that the maximum flying distance is increased to, for example, 4 mm, 20 mm, and 200 mm, respectively. Therefore, by reducing the pressure to a predetermined value or less within a range of from about 0.1 atm to about 0.5 atm, for example, the maximum flying distance of the droplet can be made 10 mm or more. According to this embodiment, it is possible to adequately increase the maximum flying distance of the droplet without increase in volume of the ink droplet.

This also allows to set the gap size of the inkjet printer 14 to be wide gap such as 10 mm or more. Therefore, according to this embodiment, it is possible to stably and adequately print in the inkjet method relative to the medium 50 having concavo-convex print surface, for example.

Similarly, for example, even in a case of the ink droplet having a small volume, reduction in pressure of the area between the nozzle 202 and the medium 50 prevents the ink from becoming fine mist and increases the maximum flying distance of the droplet, but description of concrete numeric values is omitted. Therefore, when the inkjet head 102 and the medium 50 are spaced apart from each other by a required distance, the volume of the droplet to be suitably ejected is allowed to be reduced by reducing the pressure.

Therefore, for example, even when the volume of the droplet is 1 pl or less, 0.5 pl or less, or 0.1 pl or less, the ink can be suitably ejected in a state that the inkjet head 102 is spaced apart from the medium 50 by the required distance because influence of air resistance is reduced. According to this embodiment, the influence of air resistance on the ink droplets is sufficiently and suitably reduced even when the volume of the droplet is small. In addition, even when the gap size is set to be wide gap, it is possible to stably eject ink droplets each having a small volume, thereby adequately printing a high resolution image.

Further, when the volume of the ink droplet is not so small, that is, 1 pl or more, the gap size can be set to be wide gap such as 1 cm, 2 cm, 5 cm or more. Accordingly, the aforementioned structure enables adequate printing in the inkjet method even relative to a medium 50 such as a three-dimensional article having larger concavo-convex shape.

Though the present invention has been described with regard to the embodiments, the technical scope of the present invention is not limited to the scope described in the aforementioned embodiments. It will be apparent to those skilled in the art that various modifications and improvements can be applied to the aforementioned embodiments. It is apparent from the claims of the present invention that embodiments with such modifications and improvements are within the technical scope of the present invention.

The present invention can be suitably applied to a printing system, for example.

What is Claimed as New and Desired to be Secured by Letters Patent of the United States is:

1. A printing system comprising:
an inkjet head having nozzles configured to eject ink to a concavo-convex print surface a medium; and
a decompressor configured to reduce a pressure in an area between the medium and the nozzles to be a pressure value lower than atmospheric pressure.

2. The printing system according to claim 1, further comprising:
a medium supporting portion configured to support the medium at a back surface of the medium opposite to the print surface, a distance between the nozzles and a supporting surface of the medium supporting portion being about 5 mm or more.

3. The printing system according to claim 2, wherein the inkjet head is configured to eject ink onto the print surface of the medium while moving relatively to the medium supporting portion along the supporting surface.

4. The printing system according to claim 1, wherein a distance between the print surface of the medium and a nozzle face of the inkjet head is about 5 mm or more.

5. The printing system according to claim 1, wherein a saturated vapor pressure of a main component of the ink at a temperature of 25° C. is about 1/20 atm or less.

6. The printing system according to claim 4, wherein the ink contains at least one of monomer and oligomer as a main component and is curable due to polymerization of the main component.

7. The printing system according to claim 1, wherein the decompressor is configured to reduce the pressure in the area between the medium and the nozzles to about 0.5 atm or less.

8. An inkjet printer comprising:
an inkjet head having nozzles configured to eject ink in an area between a medium and the nozzles onto a concavo-convex print surface of the medium, a pressure in the area being reduced to be a pressure value lower than atmospheric pressure.

9. A method for printing comprising:
providing a medium having a concavo-convex print surface;
reducing a pressure in an area between the medium and nozzles of an inkjet head to be a pressure value lower than atmospheric pressure; and
ejecting ink to the print surface from the nozzles.

10. The printing system according to claim 2, wherein the distance between the nozzles and a supporting surface is about 10 mm or more.

11. The printing system according to claim 2, wherein the distance between the nozzles and a supporting surface is about 200 mm or less.

12. The printing system according to claim 2, wherein the distance between the nozzles and a supporting surface is about 10 to about 20 mm.

13. The printing system according to claim 7, wherein the decompressor is configured to reduce the pressure in the area to about 0.1 atm or less.

14. The printing system according to claim 7, wherein the decompressor is configured to reduce the pressure in the area to about 0.01 atm or less.

15. A printing system comprising:
ejecting means for ejecting ink to a concavo-convex print surface a medium; and
decompressor means for reducing a pressure in an area between the medium and the nozzles to be a pressure value lower than atmospheric pressure.
